(19) United States
(12) Patent Application Publication
(10) Pub. No.: US 2014/0279673 A1
(43) Pub. Date: Sep. 18, 2014

(54) Integrated Multimedia Booth

(71) Applicants: Omer Dar, Budapest (HU); Avner Moratt, Roswell, GA (US); Itai Peer, Roswell, GA (US)

(72) Inventors: Omer Dar, Budapest (HU); Avner Moratt, Roswell, GA (US); Itai Peer, Roswell, GA (US)

(21) Appl. No.: 14/212,775

(22) Filed: Mar. 14, 2014

Related U.S. Application Data
(60) Provisional application No. 61/794,313, filed on Mar. 15, 2013.

(51) Int. Cl. G06Q 30/02; G06Q 50/00

(52) U.S. Cl. CPC G06Q 30/0282; G06Q 50/01
USPC 705/347

(57) ABSTRACT

Embodiments of the present disclosure may provide an integrated multimedia booth. The integrated multimedia booth may be operative to receive credentials from a user, enable the user to make an online endorsement of an operator of the multimedia booth prior to operating a camera of the multimedia booth, and operate the camera of the multimedia booth once the online endorsement has been made.

### RELATED APPLICATION

Under provisions of 35 U.S.C. §119(e), the Applicant claims the benefit of U.S. Provisional Application No. 61/794,313 filed on Mar. 15, 2013, which is incorporated herein by reference.

### BACKGROUND

Online social media has proven to provide a strong venue for marketing. Business entities are trying to integrate their products, services, and brands into social media through various means. The present disclosure provides an additional marketing forum by which a business entity may enter the social media marketing sphere.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks, trade dress, and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose. In the drawings:

FIG. 1 is a flow chart illustrating a method for operating an embodiment of an integrated multimedia booth;

FIG. 2 is an illustration of a second screen provided in an embodiment of an integrated multimedia booth;

FIG. 3A is an illustration of a third screen provided in an embodiment of an integrated multimedia booth;

FIG. 3B is an illustration of a fourth screen provided in an embodiment of an integrated multimedia booth;

FIG. 3C is an illustration of a fifth screen provided in an embodiment of an integrated multimedia booth;

FIG. 3D is an illustration of a sixth screen provided in an embodiment of an integrated multimedia booth;

FIG. 4 is an illustration of a seventh screen provided in an embodiment of an integrated multimedia booth;

FIG. 5A is an illustration of an eighth screen provided in an embodiment of an integrated multimedia booth;

FIG. 5B is an illustration of a ninth screen provided in an embodiment of an integrated multimedia booth;

FIG. 5C is an illustration of a tenth screen provided in an embodiment of an integrated multimedia booth;

FIG. 6 is an illustration of an eleventh screen provided in an embodiment of an integrated multimedia booth;

FIG. 7 is an illustration of a twelfth screen provided in an embodiment of an integrated multimedia booth;

FIG. 8 is an illustration of a thirteenth screen provided in an embodiment of an integrated multimedia booth;

FIG. 9 is an illustration of a fourteenth screen provided in an embodiment of an integrated multimedia booth;

FIG. 10 is an illustration of a fifteenth screen provided in an embodiment of an integrated multimedia booth;

FIG. 11 is an illustration of a sixteenth screen provided in an embodiment of an integrated multimedia booth;

FIG. 12 is an illustration of a seventeenth screen provided in an embodiment of an integrated multimedia booth;

FIG. 13 is an illustration of an eighteenth screen provided in an embodiment of an integrated multimedia booth;

FIG. 14 is an illustration of a nineteenth screen provided in an embodiment of an integrated multimedia booth; and

FIG. 15 is system diagram of a computing device operative to perform the method for operating an integrated multimedia booth.

### DETAILED DESCRIPTION

The following detailed description refers to the accompanying drawings. Wherever possible, the same reference numbers are used in the drawings and the following description to refer to the same or similar elements. While many embodiments of the present invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Embodiments of the present disclosure may provide a multimedia booth integrated with various social media outlets such as, but not limited to, Facebook, Twitter, LinkedIn, and the like. The integrated multimedia booth may comprise, but not be limited to, for example, a screen, a camera, a computing device, and a printer. Other devices may be included in the multimedia booth as well. Each of these devices may be interconnected into a single system.

Consistent with embodiments of the disclosure, users may enter the integrated multimedia booth to, for example: login using their Facebook credentials, “like” a Facebook page, operate the at least one camera to take photos and/or videos, and upload the photos and/or videos to, for example, a social media site or an email address. When the user wishes to print the photographs taken in the integrated multimedia booth, the user may be prompted to complete a survey. Once the user has completed the survey, the printer may print the photos for the user to take.

A computing device, such as computing device 1500 as illustrated in FIG. 15, may comprise a multimedia booth computer application 1520 customized to the needs of an operator of the multimedia booth. As will be detailed below, computing device 1500, in conjunction with application 1520, may be operative to perform method 100 illustrated in FIG. 1

Through this application, an operator of the multimedia booth may be able to aggregate various statistics and information on the users of the multimedia booth, including the results of the survey completed by each user. This information may, in turn, be linked to, for example, a website, and be presented in a meaningful way.

FIG. 2 illustrates one version of a login screen 200 that may be provided by computing device 1500 to a user that enters the integrated multimedia booth. The login screen may include a banner 205 showing an image, a text, a video, or combination thereof, associated with an operator of the integrated multimedia booth. Though FIG. 2 shows a user being prompted to enter a telephone number 210, various embodiments of the present disclosure may enable the user to input his Facebook credentials, or that of other different social media platforms. For example, other credentials such as a user's email address, phone number, or other identifying information may be used. Alternatively, no login credentials may need to be provided to use the integrated multimedia booth.

FIGS. 3A-3D illustrate a screen flow 300 associated with embodiments of the present disclosure. A user may desire to login using his Facebook credentials 305. The user may be prompted with a dialog boxes 310, 315, and 320 associated with the permissions required for logging in using Facebook credentials, thereby enabling the integrated multimedia booth to act on behalf of the user through the social media platform.

Once the user has logged in, he may be asked to endorse a company operating the integrated multimedia booth. For example, as illustrated in FIG. 3D, the user may be asked to “like” 330 a Facebook page. The Facebook page may be that of the company operating the integrated multimedia booth. In various other embodiments of the disclosure, the user may be asked to, for example, post a pre-written message to a website or social media forum promoting the operator of the integrated multimedia booth. This message may be pre-written by the operator. The user may then press a “Next” button 335 to proceed to the next screen.

Once the user has endorsed the operator (though endorsement may not be required) and pressed button 335, he may be taken to a screen 400 enabling him to operate a camera of the integrated multimedia booth. FIG. 4 shows one embodiment of the operation screen 400. Computing device 1500 may cause a display a frame 405 showing what the camera may currently be capturing. The booth may provide the user with options to navigate back to the previous screen button 405A, leave the screen button 405B, take photo button 410, or take video button 415. FIG. 5A shows a screen that may be displayed in response to a user selecting to take videos. The user may be prompted with a survey question in frame 550. The user may press record button 515 and address the survey question. Alternatively, the user may skip the survey question by pressing skip button 405C. Once the user is done recording, the user may press next button 405D.

FIG. 6 illustrates a screen 600 that may be provided to a user in response to selecting take photo button 410. Screen 600 may enable a user to operate the camera. For example, to operate the camera, the user may, for instance, press a “Shoot” button 605 and computing device 1500 may operate the camera to take at least one picture or at least one video of the user. In various embodiments, the user may then be displayed the at least one picture and the at least one video for review.

From there, the integrated multimedia booth may display screens 700, 800, and 900 as illustrated in FIGS. 7, 8, and 9. Computing device 1500 may enable a user to select at least one picture to post or otherwise upload to a website or email account. For example, the user may elect to post the selected at least one picture or video to a social media platform of his choosing. Element 705 may display the platform on which the user may be enabled to print (e.g., by pressing print button 905), upload or otherwise share a selected multimedia content 715. The user may also be provided with a “retake” button 710. Alternatively, the user may elect to skip the printing or sharing process by pressing skip button 405C.

The user may also be enabled to print the at least one picture taken in the integrated multimedia booth. Prior to printing, however, embodiments of the present disclosure may require the user to complete a survey. For instance, the user may be redirected to a survey provided by a survey provider such as “Survey Monkey”. Alternatively, the survey may be integrated within the application running on the computing device that is operating the multimedia booth. The questions of the survey may be established by the operator. Once the survey is compete, the user may receive a printout of the at least one picture from the printer coupled to the integrated multimedia booth. In various embodiments of the present disclosure, the user may be required to take the survey prior to posting his selected pictures or videos.

Once completed, the user may be displayed thank you screen 1000, enabling the user to end the process by selecting button 1005. In various embodiments, the user may step outside of the integrated multimedia booth and be directed to another computing device, such as a tablet, where he may be presented with screens 700-1000. The device may retrieve the captured images from, for example, computing device 1500, or a network in which the captured images were stored. In this way, the amount of time the user spends within the booth may be reduced.

The posting may be accompanied by a pre-written message set by the operator of the integrated multimedia booth. As shown in FIG. 11, computing device 1500 may enable the user may post the at least one picture or video to Facebook, along with the pre-written message 1105. It should be understood that Facebook is just one example of a social multimedia platform to which the at least one picture or video may be posted. For instance, the pre-written message may comprise hash-tags compatible with twitter, Instagram, and the like. In various embodiments, the pre-written message may be optional.

An integrated multimedia booth application running 1520 on the computing device 1500 that is operating the multimedia booth may be operative to aggregate various statistics and information on the users who enter the integrated multimedia booth. In various embodiments, the statistics may be aggregated in a centralized server. Since the user may be providing credentials for and interfacing with a social media platform when using the integrated multimedia booth, the integrated multimedia booth application may be configured to collect any information on the user from the social media platform. In addition, the integrated multimedia booth application may also be configured to provide information to the social platform.

For instance, as shown in FIG. 12 the operator (represented by, for example, name 1205) of the integrated multimedia booth may have a Facebook page which provides various statistics 1210 and 1215 on the users that “like” the Facebook page. The integrated multimedia booth application may be configured to interface with these statistics, collect and compile information, and provide them to the operator in a meaningful way. In addition, the integrated multimedia booth application may provide each user's completed survey information. This provided information may then be, in turn, presented on, for example, a website accessible to the operator of the integrated multimedia booth or emailed. FIGS. 13-14 illustrate examples (screens 1300 and 1400) of the type of statics and information (information 1305 and 1405) that may be provided to the operator. In this way, the operator may have meaningful information on the users of the integrated multimedia booth who may be, for example, his target marketing demographic.

Consistent with embodiments of the disclosure, the aforementioned integrated multimedia booth may be implemented in a computing device, such as computing device 1500 of FIG. 15. Any suitable combination of hardware, software, or firmware may be used to implement the memory storage and processing unit. For example, the memory storage and processing unit may be implemented with computing device 1500 or any of other computing devices 1518, in combination with computing device 1500. The aforementioned system, device, and processors are examples and other systems, devices, and processors may comprise the aforementioned memory storage and processing unit, consistent with embodiments of the disclosure. Furthermore, computing device 1500 may comprise an operating environment for system 100 as described above. System 100 may operate in other environments and is not limited to computing device 1500.

With reference to FIG. 15, a system consistent with an embodiment of the present disclosure may include a computing device, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include integrated multimedia booth application 1520. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable and non-removable media implemented in any method or technology for storage of information, such as computer readable instructions, data structures, program modules, or other data. System memory 1504, removable storage 1509, and non-removable storage 1510 are all computer storage media examples (i.e memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a camera, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g. integrated multimedia booth application 1520) may perform processes including, for example, one or more methods as described above. The aforementioned process is an example, and processing unit 1502 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

We claim the following:

1. A method of operating an integrated multimedia booth, comprising:
receiving credentials from a user;
enabling a user to make an online endorsement of an operator of the multimedia booth prior to operating a camera of the multimedia booth; and
operating the camera of the multimedia booth once the online endorsement has been made.

2. The method of claim 1, wherein enabling the user to make the online endorsement of the operator comprises using the credentials received from the user to facilitate the online endorsement.

3. The method of claim 1, wherein receiving the credentials from the user comprises receiving the credentials tied to an online social media platform.

4. The method of claim 3, wherein enabling the user to make the online endorsement of the operator comprises using the credentials received from the user to log the user into the online social media platform.

5. The method of claim 4, further comprising:
receiving an indication that the user has made the online endorsement of the operator, and
enabling, in response to the received indication, an operation of the camera of the multimedia booth.

6. The method of claim 5, wherein receiving the indication that the user has made the online endorsement of the operator comprises receiving a notification from the online social media platform.

7. The method of claim 1, further comprising:
receiving a command to print the multimedia content.

8. The method of claim 7, further comprising:
requiring, in response to receiving the command, the user to complete a survey.

9. The method of claim 8, further comprising:
receiving an indication that the survey has been completed, and
in response to the indication, enabling a printing of the multimedia content.

10. The method of claim 1, further comprising:
publishing, to an online platform, a multimedia content that resulted from the operating of the camera.

11. The method of claim 10, wherein publishing the multimedia content comprises publishing the multimedia content along with a message provided by the operator of the multimedia booth.

12. The method of claim 10, wherein publishing the multimedia content comprises publishing the multimedia content to the online platform using the credentials received from the user.

13. The method of claim 1, further comprising:
aggregating information associated with the user, and
providing the aggregated information to the operator.

14. The method of claim 13, wherein aggregating the information associated with the user comprises using the received credentials associated with the user.

15. The method of claim 14, wherein using the received credentials associated with the user comprises accessing information associated with a social media platform profile of the user.

16. A computer-readable medium having a set of instructions which when executed performs a method for operating an integrated multimedia booth, the method executed by the set of instructions comprising:
receiving credentials from a user;
enabling a user to make an online endorsement of an operator of the multimedia booth prior to operating a camera of the multimedia booth; and
operating the camera of the multimedia booth once the online endorsement has been made.

17. The computer-readable medium of claim 16, wherein enabling the user to make the online endorsement of the operator comprises using the credentials received from the user to facilitate the online endorsement.

18. The computer-readable medium of claim 16, wherein receiving the credentials from the user comprises receiving the credentials tied to an online social media platform.

19. The computer-readable medium of claim 16, wherein enabling the user to make the online endorsement of the operator comprises using the credentials received from the user to log the user into the online social media platform.

20. A system comprising:
a booth;
a camera; and
a computing device, wherein the computing device comprises:
a memory storage, and
a processing unit, wherein the processing unit is operative to:
receive credentials from a user,
enable a user to make an online endorsement of an operator of the booth prior to operating the camera of the booth, and
operate the camera of the booth once the online endorsement has been made.
